(19) United States
(12) Patent Application Publication
(10) Pub. No.: US 2010/0128667 A1
(43) Pub. Date: May 27, 2010

(54) METHOD OF OPERATING A WIRELESS ACCESS POINT FOR PROVIDING ACCESS TO A NETWORK

(76) Inventor: Levi Russell, Middlesex (GB)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/373,733

(22) PCT Filed: Jul. 14, 2006
(86) PCT No.: PCT/GB2006/002621

§ 371 Date: Jan. 10, 2010

(51) Int. Cl. H04W 40/00

(52) U.S. Cl. 370/328

(57) ABSTRACT

A method of operating a wireless access point 3 for providing access to a network 13 is described. Access to the network 13 is authenticated by a server 15 accessible by the wireless access point 3. The invention includes disconnecting a user of a pre-paid user from the network 1 when their pre-paid time has expired, setting a price and currency of accessing the network 1, grouping wireless access points 3 to provide a convenient method of making global changes to the group of wireless access points 3 and selecting a genre of advert to be advertised on a portal provided at a wireless access point 3.

This invention relates to a method of operating a wireless access point for providing access to a network, access to the network being authenticated by a server accessible by the wireless access point. In particular this invention relates to a method of operating a wireless access point for providing access to the Internet (commonly know as a “hotspot”).

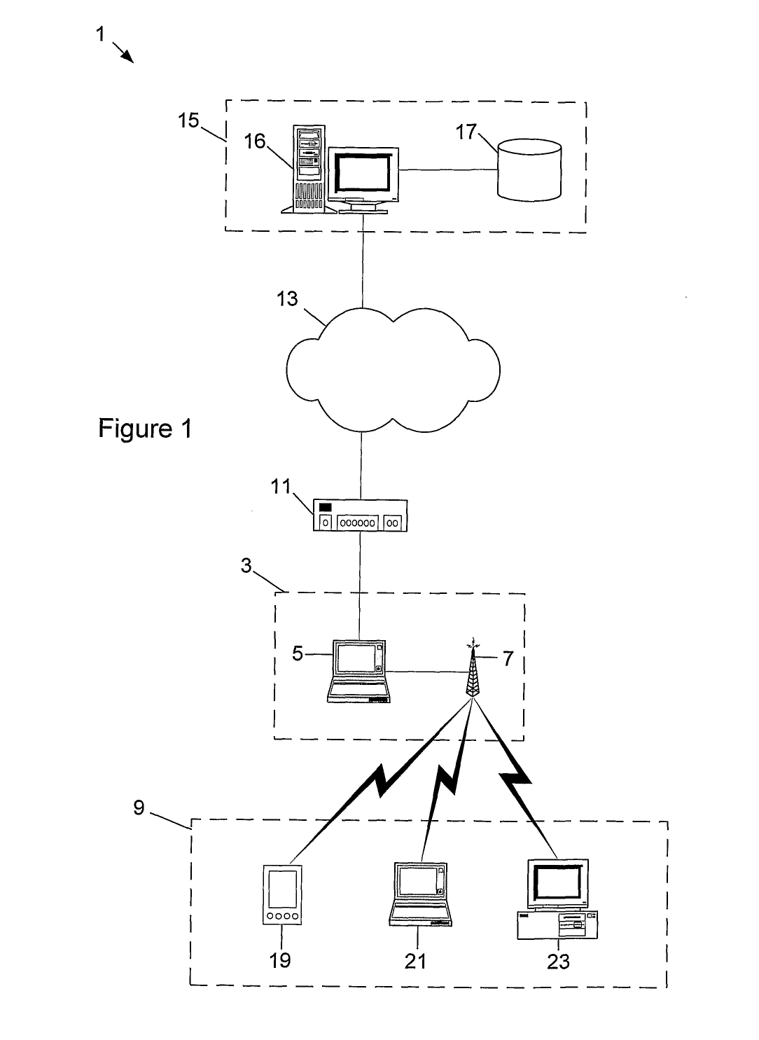

A system for connecting a wireless enabled device to a network via a wireless local area network is shown in FIG. 1, and is described in more detail in application no. PCT/GB2005/003301. The system/virtual network 1 comprises a wireless access point 3 connected via a modem 11 to a network 13, such as the Internet, and a server 15. The wireless access point 3 comprises a base station 7 for providing a wireless connection to a wireless enabled device 9 and a wireless access point controller 5 for controlling the connection of the wireless enabled device 9 to the network 13. The wireless enabled device 9 may be a personal digital assistant (PDA) 19, a laptop 21, a desktop personal computer 23 or other wireless enabled device. Such wireless enabled devices 9 are typically compliant with the IEEE 802.11 specification and/or the Bluetooth (®) specification.

The server 15 comprises a server processor 16 and a storage means/database 17. Software is stored in the storage means 17 which can be downloaded to a wireless access point 3. The storage means 17 also stores information about wireless access points 3 registered to use the virtual network 1 and subscription data associated with users of wireless enabled devices 9 subscribing to the network 1. The wireless access point 3 connects to the server 15 via the network 13.

A wireless access point 3 is commissioned by downloading and installing software from the storage means 17 and by sending data from the wireless access point 3 to the server 15 to register the wireless access point 3. The server 15 authenticates connection of a wireless enabled device 9 to the network/Internet 13 via the wireless access point 3 based on matching subscription data provided by the user of the wireless enabled device 9 with subscription data stored in the storage means 17.

This invention provides improvements to the system and method described in application no. PCT/GB2005/003301.

According to a first aspect of the invention there is provided a method of controlling an access point for connecting a device to a network, authentication of a connection to the network being provided by a server accessible to the access point, the method comprising: receiving an authentication request at the server; sending a signal from the server to initiate connection of the device to the network; receiving a reauthentication request at the server; sending a confirmation signal from the server to maintain connection of the device to the network; and repeating the step of receiving a reauthentication request and sending a confirmation signal until a disconnection signal is sent from the server in place of the confirmation signal when the device is to be disconnected from the network.

The reauthentication request may be received at the server at regular intervals, for example, between every twenty five to thirty five seconds or every thirty seconds.

According to a second aspect of the invention there is provided a method of controlling an access point for connecting a device to a network, authentication of a connection to the network being provided by a server accessible to the access point, the method comprising: sending an authentication request to the server; receiving a signal from the server to initiate connection of the device to the network; sending a reauthentication request to the server; receiving a confirmation signal from the server to maintain connection of the device to the network; repeating the step of sending a reauthentication request to the server until a disconnection signal is received from the server; and disconnecting the access point from the network when a disconnection signal is received from the server.

The reauthentication request may be sent to the server at regular intervals, for example, between every twenty five to thirty five seconds or every thirty seconds.

The authentication and maintenance of the connection of the wireless enabled device to the network may be based on subscription information associated with a user of the device, the subscription information being stored in storage means accessible to the server. The subscription information may relate to a pre-paid card or to a registered account of a user of the network and the disconnection signal may be sent when there is no credit or time remaining on the pre-paid card or in the account of the registered user of the network.

The access point may be a wireless access point and the device a wireless enabled device. Alternatively the access point may be a wired access point and the device wiredly connected to the access point.

According to a third aspect of the invention there is provided a method of setting a price for accessing a network via a wireless access point, access to the network being authenticated by a server accessible over the network by the wireless access point, the method comprising the steps of: an operator of the server setting a base price; and an operator of the wireless access point setting a premium to the base price.

The base price and premium to the base price may be stored in storage means accessible to the wireless access point. The storage means may be associated with the server and may be located proximal to or remote from the server.

The base price and the premium to the base price may be based on provision of access to the network for a fixed period of time. The first currency of the price may be based on a geographical location of the wireless access point, i.e., the local currency at the wireless access point. An operator of the wireless access point may set a price in a second currency.

According to a further aspect of the invention there is provided a method of setting a currency of a price for accessing a network via a wireless access point, access to the network being authenticated by a server accessible over the network by the wireless access point, the method comprising the steps of: setting a first currency based on a geographical location of the wireless access point; and an operator of the wireless access point setting a second currency.

The first currency may be based on a geolocation of the wireless access point. The price in the second currency may replace the price in the first currency or be in addition to the price in the first currency. The operator of the wireless access point may set a price in further currencies, so that access can be purchased in a number of different currencies.

The price in the second currency may be set by converting the price in the first currency based on a rate of exchange between the first currency and the second currency or the price may be set independently of a market rate of exchange between the first currency and the second currency.

According to a further aspect of the invention there is provided a method of setting one or more user parameters for a plurality of wireless access points through which a network is accessed, access to the network being authenticated by a server accessible over the network by the wireless access points, the method comprising the steps of associating the plurality of wireless access points with each other to form a group of wireless access points; setting a group parameter for the group of associated wireless access points; and applying the group parameter to each wireless access point in the group.

The plurality of wireless access point may be associated with each other by associating a group identifier with each wireless access point. The group identifier may be stored in storage means accessible by the server. The user parameters may comprise one or more of a currency, a price and an advertising genre.

According to a further aspect of the invention there is provided a method of identifying a prospective installer of a wireless access point, the method comprising: populating a database with contact details of prospective installers of a wireless access point, the contact details comprising location details of the prospective installers; populating the database with a number of wireless access points installed by each prospective installer; and searching the database to identify a prospective installer.

The method may further comprise populating the database with a feedback rating provided by operators of wireless access points installed by prospective installers of wireless access points. The database may be searched according to one or more of the location of prospective installers, the number of wireless access points previously installed by a prospective installer and the feedback rating provided by operators of wireless access points.

According to a further aspect of the invention there is provided a method of selecting an advertisement to be displayed on a portal of a wireless access point for providing access to a network, authentication of access to the network being provided by a server accessible by the wireless access point, the method comprising: selecting a genre of an advert to be displayed on the portal; and selecting an advert to match the advert genre.

The advert genre may be selected according to a type of location at which the wireless access point is located. An operator of the wireless access point may select the advert genre and an operator of the server may collate the adverts to be displayed on the portal. A charge may be raised each time a hyperlink associated with an advert is activated.

The method may further comprise: setting a maximum price to be paid for activation of a hyperlink associated with an advert (a maximum pay-per-click price); setting a minimum pay-per-click price for a website on which the advert is to be displayed; and selecting an advert to be displayed if the maximum price is more than or equal to the minimum price.

The above methods may be practised when the network is the Internet or another network.

According to a further aspect of the invention there is provided a server for controlling an access point providing authenticated connection of a device to a network, the server being operable to: receive an authentication request; send a signal to initiate connection of the device to the network; receive a reauthentication request; send a confirmation signal to maintain connection of the device to the network; repeat the steps of receiving a reauthentication request and sending a confirmation signal while the connection is to be maintained; and send a disconnection signal when the connection is to be disconnected.

The authentication of the connection of the wireless enabled device to the network may be based on subscription information associated with a user of the device. The subscription information may relate to a pre-paid card. The access point may be a wireless access point and the device a wireless enabled device. The network may be the Internet.

According to a further aspect of the invention there is provided a portal of a wireless access point for connecting a wireless enabled device to a network, authentication of access to the network being provided by a server accessible by the wireless access point, the portal being configurable to comprise information about the operator of the wireless access point and advertisements selectable by the operator of the wireless access point.

The invention will be further described by way of example with reference to the accompanying drawings in which:

FIG. 1 shows a system for providing authenticated wireless access to a network; and

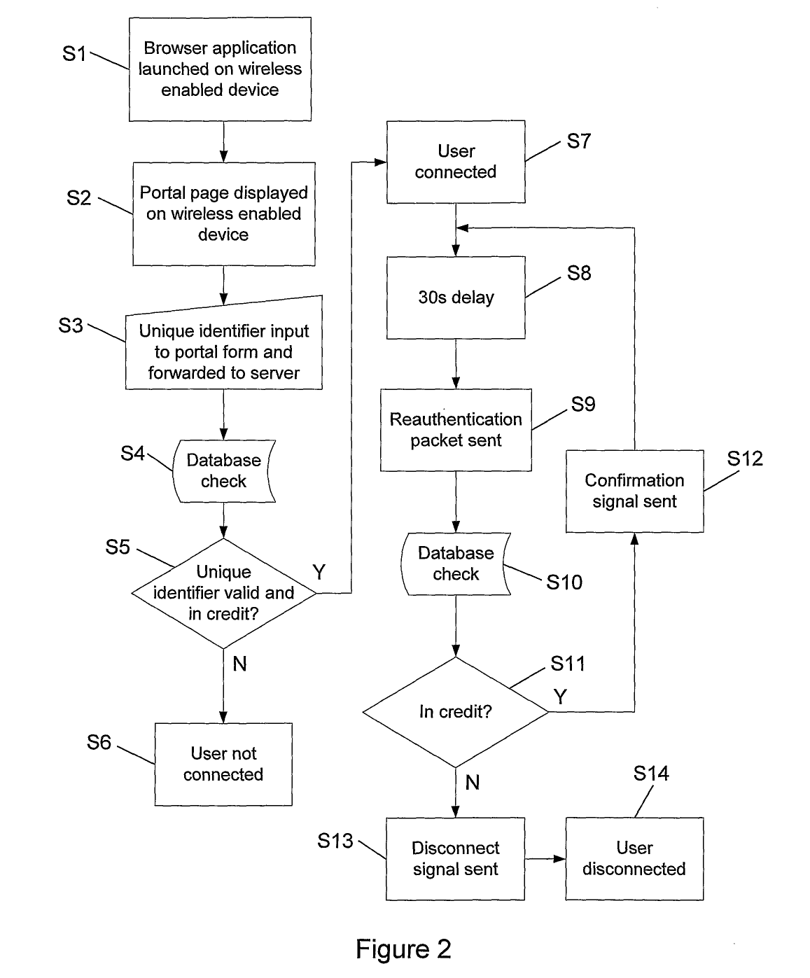

FIG. 2 is a flowchart showing a method of reauthenticating access to the network of FIG. 1 according to an embodiment of the invention.

When connecting to a network 1, a user of a wireless enabled device 9 launches a browser application and connects wirelessly to a wireless access point 3. Software installed on the wireless access point 3 causes a portal page to be displayed on the wireless enabled device 9. To connect to the network 1, the user of the wireless enabled device 9 enters a unique identifier which matches data stored in the storage means 17, such as a user name and a password. If the user is not registered to use the network 1 the user may register personal details via the portal to register. Alternatively, a pre-paid card displaying a unique identifier may be used to access the network. A pre-paid card may allow access for a pre-determined period of time, for example for sixty minutes.

To connect to the network 1 with a pre-paid card, a user enters the card's unique identifier into a field on the portal page and the identifier is sent by the wireless access point 3 to the server 15 to check if there is any credit (time) remaining for the pre-paid card. If there is credit remaining then the server 15 authenticates access to the network 1 (Internet) by the wireless enabled device 9 via the wireless access point 3. When the user of the pre-paid card disconnects from the network 1, a signal is sent to the server 15 to indicate that the user is no longer using the network, the time of use is calculated, subtracted from the credit remaining and the new outstanding credit is calculated. If there is no credit remaining then the server 15 will not allow subsequent access to the network via a wireless access point 3.

Conventionally, there is no way of disconnecting a user from the network once the number of minutes purchased by the user has expired, as the calculation of time remaining is only performed when the user disconnects from the network. Therefore, in a situation where a user has time remaining on a pre-paid card, once connected to the network 1 their connection will not be terminated after the remaining time expires but will only be terminated once the user disconnects from the network 1.

This invention relates to a method of controlling access to a network and disconnecting a user of a pre-paid card from the network when the time purchased by the user has expired.

When a wireless access point 3 is commissioned, the software installed on the wireless access point 3 includes a software routine for sending a reauthentication request/signal to the server 15. Referring to FIG. 2, when a user of a pre-paid card is authenticated by the server 15 to initially connect S7 to the network 1, a reauthentication request is sent S9 from the wireless access point 3 to the server 15 at regular intervals thereafter to check if the user is still entitled to be accessing the network. If the user has time remaining on their pre-paid card, the server 15 sends a confirmation signal S12 to the wireless access point 3 to confirm that the user is entitled to continued access, and access to the network 1 is maintained. If the user no longer has time remaining on their pre-paid card then the server 15 sends a disconnect signal S13 to the wireless access point 3. The wireless access point 3 receives the disconnect signal from the server 15 and prevents further access S14 by the wireless enabled device 9 to the network 13.

For example, if a user has five minutes of pre-paid wireless access remaining on their pre-paid card at the time of connection to the network 1, then a reauthentication packet is sent S9 from the wireless access point 3 to the server 15 at roughly thirty second intervals after connecting, and a confirmation signal is received in reply. When five minutes has passed, the next time that a reauthentication packet is sent S9 from the wireless access point 3 to the server 15, a disconnect signal is sent S13 from the server 15 to the wireless access point 3 and the wireless enabled device 9 is disconnected S14 from the network 1.

In an alternative embodiment, rather than software at the wireless access point 3 disconnecting the wireless enabled device 9 from the network 1, an application is downloaded to the wireless enabled device 9 and that application sends reauthentication packets/requests to the server 15 and processes confirmation and disconnect signals received from the server 15, to maintain the connection of the wireless enabled device 9 to the network 1 and to disconnect the wireless enabled device 9 respectively from the network 1.

This method of connecting a wireless enabled device 9 to a network for a predetermined period of time is not limited to users of a pre-paid card but can also be applied to registered users (account holders) of a wireless network and also to users of wired networks who access a network by means of a wired access point.

The system of FIG. 1 enables hotspots to be commissioned and connected to the virtual network 1 facilitated by the server 15 without the active intervention of the operator of the server 15, so that the network 1 grows as hotspot operators independently set up hotspots 3.

This invention further relates to a method of hotspot operators setting a price for accessing the virtual network 1.

The operator of the server 15 sets a base price for accessing the, network 1 via a wireless access point 3. The base price is a minimum price to be paid by a user of a wireless enabled device 9 for accessing the network 1 via a wireless access point 3, for example for a specified period of time. The operator of the server 15 may set a base price for accessing a network 1 for one hour, one day (either a calendar day or a period of twenty four hours), one week, one month or for another period of time. Part of the revenue is apportioned to the operator of the server 15 and part of the revenue is apportioned to operators of the wireless access points 3. The base price is set by the operator of the server 15 so that the operator of the server 15 receives at least a predetermined revenue each time access is purchased by a user of a wireless enabled device 9.

The operator of the wireless access point 3 may wish to increase the price charged to users of wireless enabled devices 9 accessing the network 1 via that operator's wireless access point 3. For example, the operator's wireless access point 3 may be the only wireless access point 3 in that area, or the operator of the wireless access point 3 may wish to generate a greater revenue than that generated when charging only the base price, or the operator of the wireless access point 3 may be of the opinion that users of wireless enabled devices 9 who use that operator's wireless access point 3 to access the network 1 will pay a price greater than the base price.

According to this invention the price of accessing the network 1 by means of a wireless access point 3 is made up of a base price set by the operator of the server 15 which authenticates access to the network 1 via the wireless access point 3 and a premium price set by the operator of the wireless access point 3. In this way, the operator of the wireless access point 3 is given the opportunity to set a price and is not restricted by the price set by the operator of the server 15, thereby potentially bringing in a greater revenue to the operator of the wireless access point 3. This encourages potential operators of further wireless access points 3 to set up wireless access points 3 on the network 1 at a price which will provide sufficient monetary incentive to install and operate such wireless access points 3, thus enabling the virtual network 1 to grow and increase in its utility.

Once set, the base price and premium price for accessing the network 1 by means of the wireless access point 3 are stored in the storage means 17 of the server 15.

When an operator of a wireless access point 3 downloads software from the storage means 17 and installs the software on the wireless access point controller 5 to commission the wireless access point 3, the operator of the wireless access point 3 registers the wireless access point 3 with the server 15 by entering relevant data at the wireless access point controller 5, this data then being transmitted via the network 13 to the storage means 17. The location of the wireless access point 3 may be determined by using a geo-location/geo-targeting method which determines the geographic location of the wireless access point 3 based on the wireless access point's 3 Internet protocol (IP) address.

When the server 15 determines the geographic location of the hotspot 3, the country in which the hotspot 3 is located is determined and consequently the currency used at that location is determined. The server 15 stores a currency identifier associated with that wireless access point 3 in the storage means 17 so that when a user of a wireless enabled device 9 connects to the wireless access point 3 and enquires about the price of accessing the network 1 by means of this wireless access point 3, the currency of a price for connecting to the network 1 is downloaded from the storage means 17 of the server 15 and is displayed to the user of the wireless enabled device 9 by means of a user interface thereof. Alternatively, the currency may be set as a default currency, e.g. US dollars.

This invention further relates to a method of altering or adding to the currency in which a user of a wireless enabled device 9 pays for Internet access via a wireless access point 3. For example, an operator of a wireless access point 3 located in the vicinity of a hotel which is frequented by visitors from other countries may wish to offer an alternative or additional currency to the default currency or to offer an additional currency or currencies in addition to the default currency based on the location of the wireless access point 3. If a visitor can pay for the wireless Internet access service in their own currency, this encourages such visitors to use the wireless Internet access service without incurring charges which are typically levied on purchases in foreign currencies.

The additional or alternative currencies available at the wireless access point 3 are stored in the storage means 17 and are accessible to the wireless access point 3 when a user of a wireless enabled device 9 enquires about the price of Internet access via that wireless access point 3. The price of the service in a second currency may be set by converting the price in a first currency to a price in the second currency based on a market exchange rate. Alternatively, the price in the second currency may be set independently of the market exchange rate between the first and second currencies.

A wireless access point operator may operate a plurality of wireless access points 3 in geographically distinct locations. The operator may wish to change the configuration of more than one wireless access point 3. Such changes may be made on a case by case basis, by changing the user parameters stored in the storage means 17 for a wireless access point 3. User parameters may include the currency in which access is paid, the price of access, the type and number of adverts presented at a portal/login/registration page of the hotspot etc. This invention relates to an alternative method of setting one or more user parameters for a plurality of wireless access points, by associating a plurality of wireless access points 3 to form a group and applying global changes to the group of wireless access points 3 associated with a single operator or group of operators. A group identifier can be set for each wireless access point 3 and a plurality of wireless access points 3 having the same group identifier are grouped together. Furthermore, it is possible to set group identifiers for sets of wireless access points 3 and further group identifiers for subsets or overlapping sets of that group. In this manner, user parameters can be set for a plurality of wireless access points 3 forming a group of wireless access points 3, by setting a parameter for the group of wireless access points 3.

This invention further relates to a method of identifying prospective installers of a wireless access point 3. A prospective operator of a wireless access point 3 may seek a person to install the wireless access point 3 on their behalf. This invention provides for a database of installers of wireless access points 3 containing contact details of prospective installers of a wireless access point 3, the contact details comprising location details of the prospective installers. The database may include a rating for each prospective installer according to a number of wireless access points 3 installed by that installer and an indication of the level of satisfaction of the installer's previous customers.

Means are provided for searching the database of installers to identify a prospective installer. The database can be searched according to the location of prospective installers and/or according to the number of wireless access points 3 previously installed by a prospective installer and/or the feedback provided by previous customers.

As described in application no. PCT/GB2005/003301, when a prospective user of the network 1 connects to a wireless access point 3 and launches the Internet browsing program installed on the wireless enabled device 9, the wireless access point 3 causes a login/registration web page to be displayed on the wireless enabled device 9 which prevents the user of the wireless enabled device 9 from accessing pages of the worldwide web without first logging into the network 1. The web page displayed on the wireless enabled device 9 is a portal page. Each time a wireless enabled device 9 connects to the network 1 at that wireless access point 3 the portal page is displayed on the browser of the wireless enabled device 9.

The operator of the wireless access point 3 can edit the portal page to include adverts, thereby providing a further revenue stream for the operator of the wireless access point 3. These adverts may be sourced directly by the operator of the wireless access point 3 or may be sourced centrally by the operator of the server 15. If adverts on the portal page are to be provided by the operator of the server 15 then the operator of the wireless access point 3 can set preferences for the type or genre of adverts to be advertised on that page. Examples of genres are news, apparel, leisure, sports, food, travel, entertainment, luxury goods, jewellery, local stores and local services. For example, if the operator of the wireless access point 3 is a health service provider such as a health club or gym then the operator can select the genre of adverts to be those relating to health related products. The operator can prioritise the preferred genre of adverts to be placed on the portal by selecting a first choice followed by a second and subsequent choices of preferred adverts.

The operator of a wireless access point 3 may set a price to be paid by an advertiser, for example, a price to paid to the operator of the wireless access point 3 each time an advert appearing on the portal page of the wireless access point 3 is clicked by an interested party, thereby activating a hyperlink associated with the advert. This pricing strategy is known as pay-per-click pricing. The operator of the wireless access point 3 may set a minimum pay-per-click price. If an advertiser wishes to place an advert, for example through the operator of a server 15 or through the operator of a group of wireless access points 3 (i.e., rather than directly approaching the operator of an individual wireless access point 3) then the advertiser can specify a maximum pay-per-click price that he is willing to pay. The pay-per-click price and the advert content and preferences may be uploaded to and stored in the storage means 17 of the server 15.

If the maximum pay-per-click price set by the advertiser is greater than or equal to the minimum pay-per-click price set by an operator of a wireless access point 3 then the advert may be posted from the server 15 to the wireless access point 3 to be featured on the portal page of the wireless access point 3. If the maximum pay-per-click price set by the advertiser is less than the minimum pay-per-click price set by an operator of a wireless access point 3 then the advert will not be posted on the portal page of that wireless access point 3 and may be featured on the portal page of a different wireless access point 3 for which the pay-per-click advertising price is lower than or equal to the maximum pay-per-click price set by the advertiser.

The operator of the wireless access point 3 may be paid a proportion of the pay-per-click price of the advert, for example, 70% of the pay-per-click price, and the remainder may be paid to the operator of the server 15.

In addition to advertisers setting a maximum pay-per-click price, advertisers may set categories of advert genres to match genres set by wireless access point 3 operators. Advertisers may set a number of advert genres.

An operator of a wireless access point 3 may provide further information on the portal page about themselves and their offerings. For example, if the operator of the wireless access point 3 is a health services provider such as a health club or gym then the operator can provide information about the staff, services offered, facilities and membership rates. In this manner the operator of the wireless access point 3 can use the portal presented to users of wireless enabled devices 9 connecting to the wireless access point 3 with information which can encourage the users of the wireless enabled devices to purchase services offered by the operator, providing a further revenue stream for the operator of the wireless access point 3.

Various modifications will be apparent to those in the art and it is desired to include all such modifications as fall within the scope of the accompanying claims.

What is claimed is:

1-13. (canceled)

14. A method of setting a price for accessing a network via a wireless access point, access to the network being authenticated by a server accessible over the network by the wireless access point, the method comprising the steps of:
an operator of the server setting a base price; and
an operator of the wireless access point setting a premium to the base price.

15. A method as claimed in claim 14, wherein the base price and premium to the base price are stored in storage means accessible to the wireless access point.

16. A method as claimed in claim 15, wherein the storage means are associated with the server.

17. A method as claimed in claim 14, wherein the base price and the premium to the base price are based on provision of access to the network for a fixed period of time.

18. A method as claimed in claim 14, wherein a first currency of the price is based on a geographical location of the wireless access point.

19. A method as claimed in claim 18, wherein an operator of the wireless access point sets a price in a second currency.

20. A method of setting a currency of a price for accessing a network via a wireless access point, access to the network being authenticated by a server accessible over the network by the wireless access point, the method comprising the steps of:
setting a first currency based on a geographical location of the wireless access point; and
an operator of the wireless access point setting a second currency.

21. A method as claimed in claim 18, wherein the first currency is based on a geolocation of the wireless access point.

22. A method as claimed in claim 19, wherein the price in the second currency replaces the price in the first currency.

23. A method as claimed in claim 19, wherein the price in the second currency is in addition to the price in the first currency.

24. A method as claimed in claim 19, wherein the operator of the wireless access point sets a price in further currencies.

25. A method as claimed in claim 19, wherein the price in the second currency is set by converting the price in the first currency based on a market rate of exchange between the first currency and the second currency.

26. A method as claimed in claim 19, wherein the price in the second currency is set independently of a rate of exchange between the first currency and the second currency.

27-30. (canceled)

31. A method of identifying a prospective installer of a wireless access point, the method comprising:
populating a database with contact details of prospective installers of a wireless access point, the contact details comprising location details of the prospective installers;
populating the database with a number of wireless access points installed by each prospective installer; and
searching the database to identify a prospective installer.

32. A method as claimed in claim 31, further comprising populating the database with a feedback rating provided by operators of wireless access points installed by prospective installers of wireless access points.

33. A method as claimed in claim 31, wherein the database is searched according to one or more of the location of prospective installers, the number of wireless access points previously installed by a prospective installer and the feedback rating provided by operators of wireless access points.

34. A method of selecting an advertisement to be displayed on a portal of a wireless access point for providing access to a network, authentication of access to the network being provided by a server accessible by the wireless access point, the method comprising:
selecting a genre of an advert to be displayed on the portal; and
selecting an advert to match the advert genre.

35. A method as claimed in claim 34, wherein the advert genre is selected according to a type of location at which the wireless access point is located.

36. A method as claimed in claim 34, wherein an operator of the wireless access point selects the advert genre and an operator of the server collates the adverts to be displayed on the portal.

37. A method as claimed in claim 34, wherein a charge is raised each time a hyperlink associated with an advert is activated.

38. A method as claimed in claim 37, further comprising: setting a maximum price to be paid for activation of a hyperlink associated with an advert (a maximum pay-per-click price); setting a minimum pay-per-click price for a website on which the advert is to be displayed; and selecting an advert to be displayed if the maximum price is more than or equal to the minimum price.

39. A method as claimed in claim 38, wherein the network is the Internet.

40-44. (canceled)

45. A portal of a wireless access point for connecting a wireless enabled device to a network, authentication of access to the network being provided by a server accessible by the wireless access point, the portal being configurable to comprise information about the operator of the wireless access point and advertisements selectable by the operator of the wireless access point.

46. A method of placing an advertisement on a portal of a wireless access point for providing access to a network, authentication of access to the network being provided by a server accessible by the wireless access point, the method comprising:
an operator of a wireless access point selecting a genre of an advertisement to be displayed on the portal; and
an advertiser whose goods and/or services match the genre placing an advertisement on the portal.

47. A method of placing an advertisement on a portal of a wireless access point for providing access to a network, authentication of access to the network being provided by a server accessible by the wireless access point, the method comprising:
an operator of a group of wireless access points selecting a genre of an advertisement to be displayed on the portal of one or more of the wireless access points operated by the operator; and
an advertiser whose goods and/or services match the genre placing an advertisement on the portal.

48. A method as claimed in claim 46, wherein the genre selected by the operator of the wireless access point or group of wireless access points is local goods and services and the advertiser is a local provider of goods and/or services.

49. A method as claimed in claim 46, wherein the advertisement is placed on the portal through the operator of the wireless access point or group of wireless access points.
